(19) United States
(12) Patent Application Publication
(10) Pub. No.: US 2013/0101798 A1
(43) Pub. Date: Apr. 25, 2013

(54) METHOD FOR MANUFACTURING STRENGTHENED GLASS SUBSTRATE, AND STRENGTHENED GLASS SUBSTRATE

(71) Applicant: Kazuaki HASHIMOTO, Tokyo (JP)

(72) Inventor: Kazuaki HASHIMOTO, Tokyo (JP)

(73) Assignee: HOYA CORPORATION, Tokyo (JP)

(21) Appl. No.: 13/591,552

(22) Filed: Aug. 22, 2012

Related U.S. Application Data
(60) Provisional application No. 61/546,609, filed on Oct. 13, 2011.

(30) Foreign Application Priority Data
Aug. 23, 2011 (JP) 2011-181835

(51) Int. Cl. C03C 21/00

(52) U.S. Cl. CPC C03C 21/002
USPC 428/157; 65/30.14; 428/410

(57) ABSTRACT

A method for manufacturing a strengthened glass substrate includes: a chemical strengthening step of chemically strengthening a plate glass material by ion-exchange; and a shaping step of cutting the chemically strengthened plate glass material by etching. In the chemical strengthening step, the ion-exchange is performed to satisfy the condition of 7≦Tₐᵥₑ≦50 [MPa], when the thickness of the plate glass material is denoted by t [μm], the thickness of the compressive stress layer by d [μm], the maximum compressive stress value of the compressive stress layer by F [MPa], the compressive stress integrated value of the compressive stress layer by X [MPa·μm], the thickness of the tensile stress layer by t₂ [μm], the average tensile stress value of the tensile stress layer by Tₐᵥₑ [MPa], and the relationships represented by equations X=F×d, t₂=t−2d and Tₐᵥₑ=X/t₂ are satisfied.

This application is based upon and claims the benefit of priority from Japanese Patent Application No. 2011-181835, filed on Aug. 23, 2011, and U.S. Provisional Patent Application No. 61/546,609, filed on Oct. 13, 2011, the disclosures of which are incorporated herein in their entirety by reference.

### TECHNICAL FIELD

This invention relates to a method for manufacturing a strengthened glass substrate suitable for use as, for example, a cover glass for electronic equipment such as portable equipment (portable electronic devices), and also relates to a strengthened glass substrate.

### BACKGROUND ART

In electronic equipment including portable equipment such as a mobile phone or a PDA (Personal Digital Assistant), a display screen portion of a liquid-crystal panel, an organic EL (Electro Luminescence) panel or the like is protected with a cover glass. As the cover glass, use is made of strengthened glass, for example, having a compressive stress layer formed on the surface layer. Such a cover glass is manufactured, for example, by a procedure described below. Firstly, a plate glass material is cut into a predetermined shape to obtain a small-sized glass substrate. This small-sized glass substrate is then immersed in molten salt to be chemically strengthened. After that, various types of functional films such as an anti-reflection film are formed, if necessary, on the surface of the chemically strengthened glass substrate. The glass substrate thus obtained (hereafter, sometimes referred to as the “strengthened glass substrate”) is used as a cover glass (see, for example, JP-A-2007-99557 (Patent Document 1)). According to the technique described in Patent Document 1, a cover glass is obtained by cutting a plate glass material into a small-sized glass substrate and then performing chemical strengthening on the small-sized glass substrate.

As a method of cutting a plate glass material, it has been proposed to use wet etching (chemical etching) (see, for example, JP-A-2009-167086 (Patent Document 2)) or dry etching instead of scribe cutting that is mechanically performed (see, for example, JP-A-S63-248730 (Patent Document 3)). Patent Document 3 also proposes a technique in which various types of functional films are formed on a plate glass material, and then these functional films are cut together with the plate glass material by etching.

Although the cutting of the plate glass material can be performed easily before execution of chemical strengthening (i.e. before formation of a compressive stress layer), the plate glass material is more apt to be damaged or broken when it is cut after formation of a compressive stress layer on the surface layer in comparison with before the formation of the compressive stress layer. For example, it is pointed out that when an air-cooled strengthened glass or chemically strengthened glass is tried to be cut by scribe cutting, the air-cooled strengthened glass will be shattered, while the chemically strengthened glass will not be able to be cut along a scribe line, or a glass substrate obtained by the scribe cutting will break down under a smaller load than an assumed load (see, for example, JP-A-2004-83378 (Patent Document 4)). Therefore, the technique described in Patent Document 4 proposes, in order to enable a chemically strengthened glass to be cut precisely along a scribe line, to use a chemically strengthened glass having a compressive stress layer with a thickness in a range of 10 to 30 μm, and having a compressive stress that is set within a range of 30 kgf/mm² to 60 kgf/mm² (=294 MPa to 588 MPa).

### SUMMARY OF THE INVENTION

Recently, there is a strong demand for improvement of a cover glass for use in portable equipment, in terms of productivity and merchantability such as strength and scratch resistance.

In order to improve the productivity of cover glass, it is conceivable to use a manufacturing process having a procedure in which a plate glass material is subjected to chemical strengthening and, if necessary, further subjected to other operations such as formation of various functional films or printing decoration, and then the plate glass material is cut into a predetermined shape. The use of such procedure makes it possible to improve the production efficiency since the plate glass material as a whole can be subjected to chemical strengthening and so on, instead of small-sized glass substrates being individually subjected to chemical strengthening and so on.

On the other hand, in order to improve the merchantability of the cover glass, it is conceivable to increase the thickness of a compressive stress layer for increasing the compressive stress in the compressive stress layer so that the strength of the cover glass is improved and the thickness thereof is reduced.

However, according to the aforementioned manufacturing process for improving the productivity, the plate glass material is cut after it is chemically strengthened. Therefore, in comparison with the techniques described in Patent Documents 1 to 3 in which the plate glass material is cut before it is chemically strengthened, the glass substrate is more apt to be damaged or broken when it is cut into small pieces. In this respect, it is conceivable to set the thickness and the compressive stress of the compressive stress layer as in the technique described in Patent Document 4. In this case, however, sufficient improvement in strength or reduction of thickness of the cover glass cannot be realized.

Further, when a plate glass material that has been chemically strengthened is cut by etching, occurrence of cracks during processing of the glass can be reduced, unlike mechanical processing. However, if a stress layer (compressive stress layer or tensile stress layer) is not formed appropriately by the chemical strengthening, minute cracks or scratches may be generated during the processing. This means that it is difficult to realize both the improvement in productivity and the improvement in merchantability of the cover glass by the conventional techniques as described above.

Therefore, an object of this invention is to provide a method for manufacturing a strengthened glass substrate in which, when a plate glass material is chemically strengthened and thereafter cut into small pieces by etching, a stress layer that is formed by the chemical strengthening is optimized so that the merchantability of a glass substrate thus obtained can be improved without causing fractures or damages thereto even if the plate glass material is cut into small pieces by etching after the chemical strengthening, as well as to provide such a strengthened glass substrate.

The invention has been made in order to achieve the aforementioned object.

According to a first aspect of this invention, there is provided a method for manufacturing a strengthened glass substrate comprising a chemical strengthening step of performing ion-exchange on a plate glass material to form a compressive stress layer in a surface layer of the plate glass material while forming a tensile stress layer in a deep portion other than the surface layer; and a shaping step of performing etching on the plate glass material which has been subjected to the chemical strengthening step to cut the plate glass material into small-sized glass substrates, wherein the plate glass material is prepared, consisting of alumino-silicate glass containing an alkali metal oxide; and in the chemical strengthening step, the ion-exchange is performed to satisfy the condition of 7≦Tₐᵥₑ<50 [MPa] when the thickness of the plate glass material is denoted by t [μm], the thickness of the compressive stress layer is denoted by d [μm], the maximum compressive stress value of the compressive stress layer is denoted by F [MPa], the compressive stress integrated value of the compressive stress layer is denoted by X [MPa·μm], the thickness of the tensile stress layer is denoted by t₂ [μm], the average tensile stress value of the tensile stress layer is denoted by Tₐᵥₑ [MPa], and the relationships represented by the equations X=F×d, t₂=t−2d and Tₐᵥₑ=X/t₂ are satisfied.

According to a second aspect of this invention, there is provided a method for manufacturing a strengthened glass substrate comprising a chemical strengthening step of performing ion-exchange on a plate glass material to form a compressive stress layer in a surface layer of the plate glass material while forming a tensile stress layer in a deep portion other than the surface layer; and a shaping step of performing etching on the plate glass material which has been subjected to the chemical strengthening to cut the plate glass material into small-sized glass substrates, wherein the plate glass material is prepared, consisting of alumino-silicate glass containing an alkali metal oxide; and in the chemical strengthening, the ion-exchange processing is performed to generate such a tensile stress that the plate glass material is not damaged by the etching.

According to a third aspect of this invention, there is provided the invention according to the first or the second aspect, further comprising, after the chemical strengthening step and before the shaping step, a decorating layer formation step of forming one or more decorating layers on at least one of the surfaces of the plate glass material which has been subjected to the ion-exchange, wherein in the shaping step performed after the decorating layer formation step, the plate glass material having the decorating layer formed thereon is cut by the etching.

According to a fourth aspect of this invention, there is provided the invention according to the third aspect, wherein the decorating layer formation step comprises a printing operation of performing printing on the major surface of the plate glass material with its end face being held.

According to a fifth aspect of this invention, there is provided the invention according to the third or the fourth aspect, wherein the decorating layer formation step comprises an operation of forming a conductive layer and a transparent conductive layer on the major surface of the plate glass material.

According to a sixth aspect of this invention, there is provided the method for manufacturing a strengthened glass substrate according to any one of the first through the fifth aspects, wherein as the plate glass material, used is a glass containing 50 to 75% by weight of SiO₂, 5 to 20% by weight of Al₂O₃, and at least one alkali metal oxide selected from Li₂O, Na₂O and K₂O.

According to a seventh aspect of this invention, there is provided the method for manufacturing a strengthened glass substrate according to the sixth aspect, wherein as the plate glass material, used is a glass containing 8% by weight or more of Na₂O and 8% by weight or less (including 0) of CaO.

According to an eighth aspect of this invention, there is provided the method for manufacturing a strengthened glass substrate according to any one of the first through the seventh aspects, wherein the strengthened glass substrate is a glass substrate for use as a cover glass for electronic equipment.

According to a ninth aspect of this invention, there is provided a strengthened glass substrate consisting of an alumina-silicate glass containing an alkali metal oxide, having a compressive stress layer in a surface layer and a tensile stress layer in a deep portion, wherein the strengthened glass substrate is subjected to ion-exchange satisfying the condition of 7≦Tₐᵥₑ<50 [MPa] when the thickness of the alumino-silicate glass is denoted by t [μm], the thickness of the compressive stress layer is denoted by d [μm], the maximum compressive stress value of the compressive stress layer is denoted by F [MPa], the compressive stress integrated value of the compressive stress layer is denoted by X [MPa·μm], the thickness of the tensile stress layer is denoted by t₂ [μm], the average tensile stress value of the tensile stress layer is denoted by Tₐᵥₑ [MPa], and the relationships represented by the equations X=F×d, t₂=t−2d and Tₐᵥₑ=X/t₂ are satisfied; and the strengthened glass substrate has an end face which has been subjected to etching.

According to a tenth aspect of this invention, there is provided the strengthened glass substrate according to the ninth aspect, wherein the end face of the strengthened glass substrate has a pair of curved faces projecting outward in a thickness direction of the major surface and an apex projecting from the curved faces outward in a planar direction of the glass base.

According to an eleventh aspect of this invention, there is provided the strengthened glass substrate according to the ninth or the tenth aspect, wherein no compressive stress layer is formed at least in a partial region of the end face of the strengthened glass substrate.

According to a twelfth aspect of this invention, there is provided the invention according to any one of the ninth through the eleventh aspects, wherein the alumino-silicate glass is a glass containing, as glass components, 50 to 75% by weight of SiO₂, 5 to 20% by weight of Al₂O₃, and at least one alkali metal oxide selected from Li₂O, Na₂O and K₂O.

According to a thirteenth aspect of this invention, there is provided the invention according to the twelfth aspect, wherein the alumino-silicate glass is a glass containing 8% by weight or more of Na₂O and 8% by weight or less (including 0) of CaO.

According to a fourteenth aspect of this invention, there is provided the invention according to any one of the ninth through the thirteenth aspects, wherein the strengthened glass substrate is a glass substrate for use as a cover glass for electronic equipment.

The invention makes it possible to cut a plate glass material into small pieces without causing fractures or damages thereto even if the plate glass material is chemically strengthened and thereafter cut by etching. Therefore, it is possible to improve the productivity in manufacture of a strengthened glass substrate. Moreover, the merchantability of the strengthened glass substrate obtained by cutting into small pieces can be improved. Thus, according to this invention, improvement of both productivity and merchantability of the strengthened glass substrates thus produced can be realized.

### BRIEF DESCRIPTION OF THE DRAWINGS

FIG. 1 is a cross-sectional view showing a configuration example of a part of portable equipment having a cover glass mounted thereon;

FIG. 2 is a cross-sectional side view schematically showing internal stress distribution in a chemically strengthened glass;

FIG. 3 is a flowchart showing summary of a procedure of a method for manufacturing a glass substrate;

FIG. 4 is a flowchart showing summary of a procedure of a shaping step in the method for manufacturing a glass substrate;

FIG. 5 is an explanatory diagram showing other specific examples of relationship of compressive stress and processability of chemically strengthened glass; and

FIG. 6 is a diagram showing a shape of an end of a glass substrate obtained by etching.

### DESCRIPTION OF EXEMPLARY EMBODIMENTS

An embodiment of the invention will be described with reference to the drawings.

In the description of the embodiment, a glass substrate that is an object to be manufactured will be described in the first place. Then, summary of a method for manufacturing the glass substrate, characteristic steps in the manufacturing method, and advantageous effects provided by the embodiment will successively be described.

### <1. Glass Substrate>

In this embodiment, a cover glass for use in portable equipment will be described as an example of a glass substrate to be manufactured.

FIG. 1 is a cross-sectional view showing a configuration example of a part of portable equipment having a cover glass mounted thereon.

In the shown portable equipment, a cover glass 1 is arranged so as to cover an image display panel 2 provided in the portable equipment with a distance D left from a display screen thereof. Thus, the display screen portion of the image display panel 2 is protected by the cover glass 1. In the shown example, a focus is placed on a configuration of the display screen portion while other components are omitted from the drawing. Although the illustrated example shows a case in which the image display panel 2 is a liquid-crystal display panel, i.e., a case in which a liquid-crystal layer 23 is held between a pair of glass substrates 21, 22, the image display panel 2 is not limited thereto but may be, for example, an organic EL panel. Further, the glass substrate can be used not only as the cover glass 1 protecting a display screen portion of portable equipment, and can be used also as a glass substrate for a casing of portable equipment.

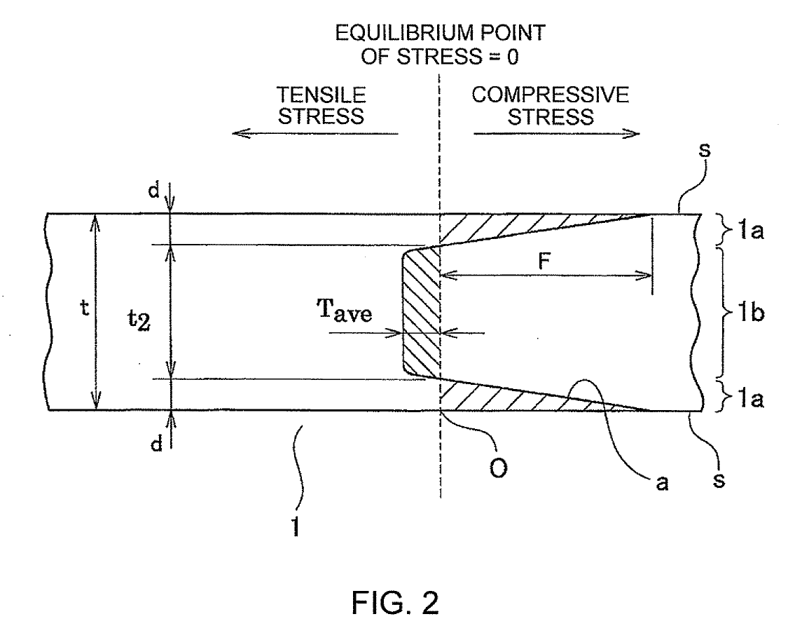

FIG. 2 is a cross-sectional side view schematically showing internal stress distribution in a chemically strengthened glass.

A chemically strengthened glass which has been subjected to ion-exchange is used as the cover glass 1. The chemically strengthened glass has compressive stress layers 1a, in which compressive stress is generated, in surface layers extending from the external surfaces (including both the top face and the rear face) to a predetermined depth in a thickness direction. The chemically strengthened glass also has a tensile stress layer 1b, in which tensile stress is generated, in a deep portion other than the surface layers (that is a region around the center in a thickness direction).

When such a glass substrate is used in a cover for portable electronic equipment, since a compressive stress layer is formed on the glass surface exposed on the surface of the display, this compressive stress layer exhibits its scratch resistance properties. Further, even if fine cracks or scratches are formed on the surface due to the compressive stress layer action, these cracks can be prevented from developing into the inside of the glass, and hence a high mechanical strength can be maintained.

The use of such a chemically strengthened glass makes it possible to maintain a high mechanical strength even if the thickness of the glass is small. Further, when such a chemically strengthened glass having a small thickness is mounted on the portable equipment as the cover glass 1, the cover glass 1 is difficult to be warped by external force due to its high mechanical strength, which makes it possible to set a narrow distance between the cover glass 1 and the display screen of the image display panel 2. As a result, the thickness of the portable equipment can be reduced.

### <2. Composition of Glass Substrate>

An alumino-silicate glass containing an alkali metal oxide can be suitably used as a glass used for a glass substrate according to the invention. The alumino-silicate glass is enabled by an ion-exchange-type chemical strengthening method to exhibit desirable compressive stress, compressive stress layer, and tensile stress precisely, and hence to provide advantageous effects of the invention in a desirable manner. Preferably, this alumino-silicate glass is a glass having a composition consisting of 50 to 75% by weight of SiO₂, 5 to 20% by weight of Al₂O₃, and at least one alkali metal oxide selected from Li₂O, Na₂O, and K₂O. The alumino-silicate glass according to the invention preferably further contains 8% by weight or more of Na₂O and 8% by weight or less (including 0) of CaO.

The alumino-silicate glass according to the invention preferably has a composition consisting of 50 to 75% by weight of SiO₂, 5 to 20% by weight of Al₂O₃, 0 to 5% by weight (including 0) of B₂O₃, 8 to 25% by weight of Na₂O, 0 to 6% by weight (including 0) of Li₂O, and 15% or less (including 0) of K₂O.

A chemical strengthening glass substrate applied to the invention contains SiO₂, Al₂O₃ and Na₂O and may further contain, if necessary, B₂O₃, Li₂O, K₂O, MgO, CaO, SrO, BaO, ZnO, ZrO₂, Fe₂O₃, SnO₂ and the like.

(SiO₂)

SiO₂ is an essential component forming the basis of glass used for a glass substrate, and has an effect to enhance the chemical durability and heat resistance of the glass. If the content thereof is less than 50%, the etching rate tends to be improved when the glass substrate is shaped by etching, but vitrification becomes difficult, and the aforementioned effect cannot be obtained sufficiently. On the other hand, when the content exceeds 75%, devitrification of the glass tends to occur, which makes it difficult to melt or shape the glass material. In addition, the viscosity is also increased to make it difficult to homogenize the glass, leading to difficulty in mass production of inexpensive glass using a down-draw method. Further, when the content exceeds 75%, the low-temperature viscosity will rise excessively and the ion exchange rate is thereby decreased, which makes it impossible to obtain a sufficient strength even after the glass is chemically strengthened by ion exchange. Accordingly, the content of SiO₂ should be 50 to 75%, preferably 53 to 70%, more preferably 55 to 67%, still more preferably 58 to 65%, and particularly preferably 60 to 65%. In this embodiment, the low-temperature viscosity shall be a temperature at which the vicinity becomes around 107.6 dPa·s.

(Al₂O₃)

Al₂O₃ is an essential component forming the basis of glass used for a glass substrate, and has an effect to enhance the chemical durability and heat resistance of the glass, and to increase the ion exchange performance and the etching rate when a shaping is performed by etching. When the content of Al₂O₃ is less than 5%, the aforementioned effect cannot be obtained sufficiently. On the other hand, when the content of Al₂O₃ exceeds 20%, it becomes difficult to melt the glass and the viscosity of the glass is increased, leading to difficulty in shaping. This makes it difficult to mass-produce inexpensive glass by using a down-draw method. Further, since the acid resistance is reduced excessively when the content of Al₂O₃ exceeds 20%, the obtained glass is not suitable for a cover glass used as a protection member. When the content of Al₂O₃ exceeds 20%, the glass becomes apt to devitrificate and the anti-devitrification properties deteriorate. Therefore, the glass is not applicable to the down-draw method. Accordingly, the content of Al₂O₃ should be 5 to 20%, preferably 5 to 17%, and more preferably 7 to 16%.

According to this embodiment, when the content of SiO₂ is represented by X and the content of Al₂O₃ is represented by Y, it is desirable that X−½·Y is 57.5% or less. When X−½·Y is 57.5% or less, the etching rate of the glass substrate can be improved effectively. X−½·Y is more preferably within a range of 56% or less, and still more preferably within a range of 55% or less.

In contrast, when X−½·Y is less than 45%, even though the etching rate is 5 μm/min or more, the devitrification temperature is increased, leading to degradation of anti-devitrification properties. Accordingly, in order to improve both the anti-devitrification properties and the etching rate, the aforementioned X−½·Y is preferably 45% or more, more preferably 47% or more, and particularly preferably 50% or more.

(B₂O₃)

B₂O₃ is a component arbitrarily added to reduce the viscosity of glass and to promote melting and clarity of glass used as a glass substrate. When its content exceeds 5%, the acid resistance of the glass is reduced while vaporization is increased, which makes it difficult to homogenize the glass. The increased vaporization also causes unevenness in the glass, leading to uneven etching of the glass substrate. Specifically, since the etching rate becomes unequal from region to region of the glass, a glass substrate containing excessive B₂O₃ is not adequate when it is to be etched for shaping with high precision. If the content exceeds 5%, the strain point will drop excessively, leading to a problem that the glass is deformed when the glass substrate is heat treated. Accordingly, the content of B₂O₃ preferably 0 to 5%, more preferably 0 to 3%, still more preferably 0 to less than 2%, and particularly preferably less than 0.01%. It is particularly preferable that no B₂O₃ is intentionally added except that it is introduced as an impurity. When the content of B₂O₃ is set to 0 to 5%, not only the etching rate can be improved, but also etching unevenness can be prevented, whereby a cover glass with higher quality can be obtained.

(Na₂O)

Na₂O is an ion-exchange component, and is an essential component which reduces the high-temperature viscosity of glass used as a glass substrate and improves the meltability and formability of the glass. Na₂O is also a component to improve the anti-devitrification properties of the glass. When the content of Na₂O is less than 8%, the meltability of the glass is reduced, leading to increased cost for melting, In addition, when the content of Na₂O is less than 8%, the ion exchange performance will also be degraded, and hence a sufficient strength cannot be obtained. Further, when the content of Na₂O is less than 8%, the coefficient of thermal expansion will drop excessively, which makes it difficult to match the coefficient of thermal expansion with those of peripheral materials such as a metal and an organic adhesive. Furthermore, when the content of Na₂O is less than 8%, the glass becomes apt to be devitrificated, and its anti-devitrification properties will also be degraded. Therefore, the glass is not applicable to a down-draw method. This makes it difficult to mass-produce inexpensive glass. In contrast, when the content exceeds 25%, the low-temperature viscosity will drop, the coefficient of thermal expansion will be increased excessively, the anti-shock properties will be degraded, and it will become difficult to match the coefficient of thermal expansion with those of peripheral materials such as a metal and an organic adhesive. Consequently, the content of Na₂O should be 8 to 25%, more preferably 10 to 20%, still more preferably 12 to 20%, and particularly preferably 13 to 19%.

(Li₂O)

Li₂O is one of ion-exchange components and is a component arbitrarily added in order to reduce the viscosity of glass used as a glass substrate and to improve the meltability and formability of the glass. Li₂O is also a component for improving the Young's modulus of the glass substrate. Further, Li₂O has a relatively high effect to increase the depth of a compressive stress layer among alkali metal oxides. However, when the content of Li₂O is too high, it will cause a problem that ion-exchanged salt is deteriorated rapidly in ion-exchange that is a step of strengthening the glass substrate, possibly resulting in increased manufacturing cost of the cover glass. Further, when the content of Li₂O is too high, the coefficient of thermal expansion of the glass will become too low, which will degrade the heat resistance and anti-shock properties of the glass, and will make it difficult to match the coefficient of thermal expansion with those of peripheral materials such as a metal and an organic adhesive. Furthermore, when the content of Li₂O is too high, not only the heat resistance (strain point and glass transition point) drops too low, but also the low-temperature viscosity is reduced excessively, whereby stress relaxation is caused to occur in a heating step after the chemical strengthening, which will reduce the stress value of the compressive stress layer. As a result, a cover glass with a sufficient strength cannot be obtained. Accordingly, the content of Li₂O should be 0 to less than 8%, preferably 0 to 6%, more preferably 0.1 to 5%, and still more preferably 0.2 to 2%.

(K₂O)

K₂O is a component arbitrarily added to improve the ion exchange performance of a glass substrate. K₂O is also a component which not only reduces the high-temperature viscosity of the glass and improves the meltability and formability of the glass, but also improves the anti-devitrification properties. However, if the content of K₂O is too high, the low-temperature viscosity will be reduced, the coefficient of thermal expansion will be increased excessively, and the anti-shock property will be degraded. Therefore, the glass becomes unsuitable for a cover glass. Further, if the content of K₂O is too high, it becomes difficult to match the coefficient of thermal expansion with those of peripheral materials such as a metal and an organic adhesive. Therefore, the content of K₂O should be less than 15%, preferably less than 10%, more preferably less than 5%, and still more preferably less than 4%. On the other hand, the lower limit of the content of K₂O is 0% or more, preferably 0.1% or more, more preferably 1% or more, and still more preferably 2% or more. When the lower limit of the content of K₂O is set to the above-mentioned range, the time required for ion-exchange can be shortened, and the productivity of the cover glass can be improved.

(R1₂O) (R1 Denotes All the Elements Among Li, Na, and K, Contained in the Glass Substrate)

In this embodiment, the content of R1₂O (the total of content percentages of all the elements among Li, Na, and K that are contained in the glass substrate) is preferably 10 to 30%. If the content of R1₂O is less than 10%, ion exchange cannot be performed sufficiently, and hence a sufficient strength cannot be obtained. Therefore, the glass cannot be used as a cover glass. In contrast, if the content of R1₂O exceeds 30%, the chemical durability of the glass is deteriorated. Therefore, in order to attain both high mechanical strength and excellent anti-devitrification properties, and to improve the chemical durability and the productivity, the content of R1₂O should more preferably be 10 to 28%, still more preferably 13 to 25%, still more preferably 14 to 24%, and particularly preferably 17 to 23%.

It should be noted that the aforementioned range of the content of R1₂O is a range defined on the condition that oxides of all the elements among Li, Na, and K that are contained in the glass satisfy the aforementioned ranges of contents.

(MgO)

MgO is a component arbitrarily added to reduce the viscosity of glass used as a glass substrate and to promote the melting and clarity of the glass. Among alkali earth metals, MgO raises the density of glass at a rather low ratio, and hence MgO is an effective component in order to improve the meltability while ensuring light weight of the glass. Further, MgO also functions as a component to improve the formability and to increase the strain point and Young's modulus of the glass. Furthermore, a precipitate which is generated when MgO-containing glass is etched, for example, with hydrofluoric acid has a high solubility and is generated at a relative low rate. Therefore, the possibility that crystals deposit on the surface of the glass being etched is relatively low. It is thus desirable to add MgO in order to improve the meltability of the glass and to obtain a high etching rate at the same time. However, if the content of MgO is too great, the anti-devitrification properties are degraded, and it becomes difficult to mass-produce inexpensive glass using a down-draw method. Accordingly, the content of MgO should be 0 to 15%, preferably from more than 1% to 15%, more preferably from more than 1% to 12%, more preferably from more than 1% to less than 7%, still more preferably from 3% to less than 7%, and particularly preferably from more than 4.5% to 6%. When MgO is contained in a range of 0 to 15%, the glass can be melted at a lower temperature, and hence the manufacturing cost of cover glass can be reduced further. Further, since improvement of both the ion exchange performance and the strain point can be attained, the glass can be suitably used as a cover glass for which a high mechanical strength is required. This is because a sufficient compressive stress layer can be formed on the surface of the glass substrate and stress relaxation or dissipation of the compressive stress layer formed on the surface can be prevented even if heat treatment is carried out.

(CaO)

CaO is a component arbitrarily added to reduce the viscosity of glass used as a glass substrate and to promote the melting and clarity of the glass. Among alkali earth metals, CaO raises the density of glass at a rather low ratio, and hence CaO is an advantageous component in order to improve the meltability while ensuring light weight of the glass. Further, CaO also functions as a component to improve the formability and to increase the strain point and Young's modulus of the glass. However, if the content of CaO is too high, the anti-devitrification properties are degraded, which makes it difficult to mass-produce inexpensive glass with use of a down-draw method. Further, if the content of CaO is too high, the ion exchange performance is also degraded and hence a sufficient strength cannot be obtained, leading to reduced productivity. Further, a precipitate (chemical substance) that is generated when glass containing a large amount of CaO is wet-etched for example with hydrofluoric acid is not only insoluble in the etching solution, but also is precipitated at a very high rate. Therefore, the precipitate tends to be deposited on the surface of the glass to be etched, and may possibly disturb the etching reaction if the amount of the precipitate is remarkably large. This will reduce the processing productivity of the glass and will deteriorate the quality of the surface of the glass after etching. This means that when CaO is added, the CaO not only degrades the surface quality of the cover glass after etching, but also disturbs the progress of etching if a large amount of chemical substance is deposited on the glass surface, possibly leading to prolonged etching time or reduced shape accuracy. On the other hand, addition of CaO makes it possible to lower the devitrification temperature and to improve the anti-devitrification properties and meltability. Therefore, the content of CaO should be 0% to 8%, preferably 0% to 5%, more preferably 0% to 4%, and still more preferably 0% to 2%. If an extremely high etching processing quality is required, it is desirable that substantially no CaO be added.

In order to obtain a glass substrate that is suitable for chemical strengthening by ion exchange with potassium ions, and also suitable for etching, it is preferable to use glass of a composition including 8% or more of Na₂O and 8% or less (including 0%) of CaO.

(SrO)

SrO is a component arbitrarily added to reduce the viscosity of glass used as a glass substrate and to promote the melting and clarity of the glass. SrO also functions as a component to improve the formability and to increase the strain point and the Young's modulus of the glass. However, if the content of SrO is too high, the density of the glass will be increased. The glass with an increased density is not suitable for a cover glass which is required to be lightweight. Further, when the content of SrO is too high, the coefficient of thermal expansion will be excessively increased, which will make it difficult to match the coefficient of thermal expansion with those of peripheral materials such as a metal and an organic adhesive. Furthermore, when the content of SrO is too high, the ion exchange performance will be degraded, and thus a mechanical strength required for a cover glass cannot be obtained. Accordingly, the content of SrO should preferably be 0 to 10%, more preferably 0 to 5%, still more preferably 0 to 2%, still more preferably 0 to 0.5%, and particularly preferably, no SrO is intentionally added except that it is introduced as an impurity.

(BaO)

BaO is a component arbitrarily added to reduce the viscosity of glass used as a glass substrate and to promote the melting and clarity of the glass. BaO also functions as a component to improve the formability and to increase the strain point and the Young's modulus of the glass. However, if the content of BaO is too high, the density of the glass will be increased. The glass with an increased density is not suitable for a cover glass which is required to be lightweight. Further, when the content of BaO is too high, the coefficient of thermal expansion will be excessively increased, which will make it difficult to match the coefficient of thermal expansion with those of peripheral materials such as a metal and an organic adhesive. Furthermore, when the content of BaO is too high, the ion exchange performance will be degraded, and thus a mechanical strength required for a cover glass cannot be obtained. Accordingly, the content of BaO is preferably 0 to 10%, more preferably 0 to 5%, still more preferably 0 to 2%, and still more preferably 0 to 0.5%. Since BaO has a significant environmental load, it is particularly preferable that the content of BaO is less than 0.01% and rather no BaO is intentionally added except that it is introduced as an impurity.

(ZnO)

ZnO is a component arbitrarily added to enhance the ion exchange performance. ZnO is a component particularly effective to increase the compressive stress value and to reduce the high-temperature viscosity without reducing the low-temperature viscosity of the glass. However, when the content of ZnO is too high, phase separation of glass occurs and the anti-devitrification properties will be degraded. Further, when the content of ZnO is too high, the density of the glass will be increased. The glass with an increased density is not suitable for a cover glass which is required to be lightweight. Accordingly, the content of ZnO is preferably 0 to 6%, more preferably 0 to 4%, still more preferably 0 to 1%, and more preferably 0 to 0.1%. It is particularly preferable that the content is less than 0.01%, and rather no ZnO is intentionally added except that it is introduced as an impurity.

(ZrO₂)

ZrO₂ is a component arbitrarily added to remarkably improve the ion exchange performance and to increase the viscosity and strain point around a devitrification temperature of the glass. ZrO₂ also functions as a component to improve the heat resistance of the glass. However, when the content of ZrO₂ is too high, the devitrification temperature will be increased and the anti-devitrification properties are degraded. Accordingly, in order to prevent degradation of the anti-devitrification properties, the content of ZrO₂ is preferably 0 to 10%, more preferably 0 to 6%, still more preferably 0 to 4%, and still more preferably 0.1 to 3%.

(Fe₂O₃)

Fe₂O₃ is a coloring component having an effect on transparency and visible transmittance of glass. When the content of Fe₂O₃ is too high, the glass becomes unstable and will be devitrificated. Therefore, the content of Fe₂O₃ is preferably 0 to 4%, more preferably 0 to 1%, still more preferably 0 to 0.1%, and particularly preferably no Fe₂O₃ is intentionally added except that it is introduced as an impurity.

(SnO₂)

SnO₂ is used as a clarificant for glass, and has an effect to improve the ion exchange performance. However, if the content of SnO₂ is too high, devitrification tends to occur or the transmittance tends to drop. Therefore, the content of SnO₂ is preferably 0 to 2%, and more preferably 0.1 to 1%.

Table 1 below shows examples of glass compositions (Samples No. 1 to No. 6) applicable to a glass substrate according to the invention. The values of compressive stress layer, compressive stress, and Tₐᵥₑ shown in Table 1 are those obtained when the glass is chemically strengthened under the conditions to be described later.

TABLE 1

| | | No. 1 | No. 2 | No. 3 | No. 4 | No. 5 | No. 6 |
|---|---|---|---|---|---|---|---|
| Glass | SiO₂ | 63.2 | 65.0 | 60.5 | 64.5 | 59.9 | 56.5 |
| composition | Al₂O₃ | 12.6 | 15.1 | 19.0 | 15.0 | 10.5 | 14.0 |
| (wt %) | B₂O₃ | — | — | — | — | — | 2.0 |
| | Li₂O | 0.2 | 3.9 | 2.5 | 3.0 | — | — |
| | Na₂O | 15.6 | 11.2 | 13.7 | 12.0 | 12.6 | 14.5 |
| | K₂O | 3.2 | 0.4 | 0.2 | 0.5 | 9.2 | 4.9 |
| | MgO | 5.2 | 0.7 | 0.2 | 1.0 | 4.0 | 3.0 |
| | CaO | — | 1.6 | 2.0 | 2.0 | | 1.0 |
| | ZrO₂ | — | 2.0 | 1.9 | 2.0 | 3.8 | 4.0 |
| | Fe₂O₃ | — | 0.1 | — | — | — | — |
| | SnO₂ | — | — | — | — | — | 0.1 |

| | | | | | | |
|---|---|---|---|---|---|---|
| Compressive stress | 40 | 47 | 36 | 62 | 30 | 30 |
| layer (μm) | | | | | | |
| Compressive stress | 500 | 380 | 440 | 460 | 520 | 650 |
| (MPa) | | | | | | |
| Glass thickness (mm) | 0.5 | 0.5 | 0.5 | 0.7 | 0.5 | 0.7 |
| Tₐᵥₑ (MPa) | 47.6 | 41.7 | 37.0 | 49.5 | 35.4 | 30.5 |

### <3. Summary of Method for Manufacturing Glass Substrate>

Summary of a method for manufacturing a cover glass 1 as an example of a glass substrate will be described.

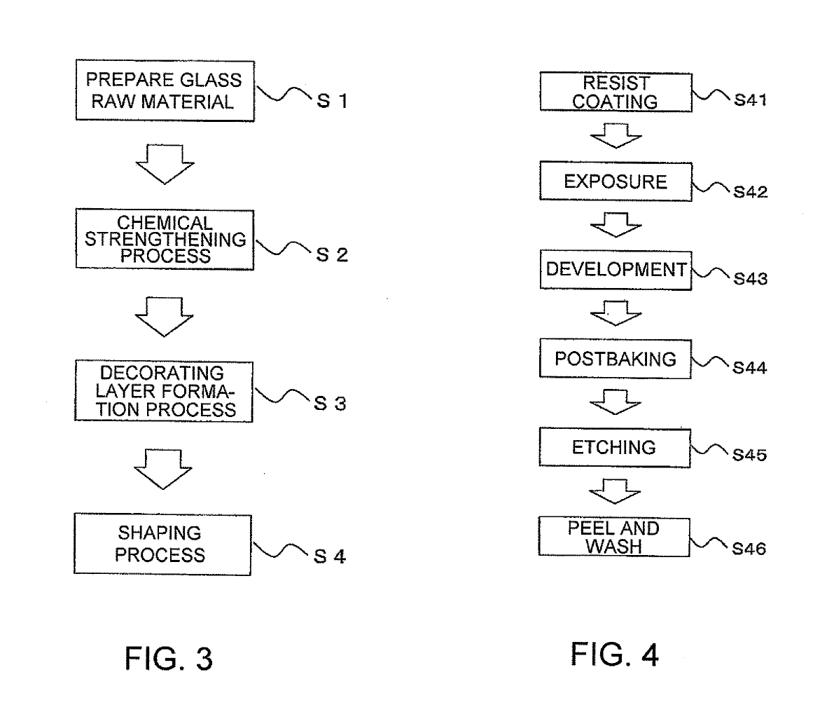

FIG. 3 is a flowchart showing summary of a procedure of a method for manufacturing a glass substrate.

In order to manufacture a cover glass 1, a glass raw material to form a cover glass 1 is prepared (step 1, hereafter, step is abbreviated as “S”). As the glass raw material, it is conceivable to use a plate glass material (sheet glass) obtained by shaping melted glass into a sheet shape by using a known method such as a down-draw method. The plate glass material to be prepared should be composed by containing one or more alkali metal components, in addition to SiO₂ as an essential component forming the base of the glass. The one or more alkali metal components may be essential components such as Na₂O and Li₂O which are used in ion-exchange to be described later. Na₂O is a component to be used in ion-exchange in order to chemically strengthen the glass by being substituted principally with potassium ions. Li₂O is a component to be used in ion-exchange in order to chemically strengthen the glass by being substituted principally with sodium ions. Li₂O has a higher ion exchange rate than Na₂O and is therefore used to form a deep compressive stress layer in a short period of time. Alumino-silicate glass is one of specific examples of a plate glass material composed of such components.

After preparing the plate glass material as the glass raw material, the plate glass material is sequentially subjected to a chemical strengthening step (S2), a decorating layer formation step (S3) and a shaping step (S4). Hereinafter, these steps (S2 to S4) will be described in sequence.

(Chemical Strengthening Step)

In a chemical strengthening step (S2), the prepared plate glass material is brought into contact with a molten salt containing one or more alkali metal components so that the plate glass material is subjected to ion-exchange. Specifically, the plate glass material is immersed for a predetermined period (e.g. 2 to 8 hours) in a process liquid consisting of a simple salt of potassium nitrate (KNO₃) or a mixed salt of potassium nitrate and sodium nitrate (NaNO₃) and held at a predetermined temperature (e.g. 350° C. to 500° C.). The glass compositions of Samples No. 1 to No. 6 in Table 1 were processed under the strengthening conditions of the mixing ratio between potassium nitrate and sodium nitrate of 9:1, the temperature of the molten salt of 400° C., and the immersing time of three hours.

When the plate glass material containing one or more alkali metal components is brought into contact with the molten salt containing one or more alkali metal components, alkali metal ions (e.g. sodium Na+) forming the plate glass material are substituted with alkali metal ions greater than those alkali metal ions (e.g. potassium K+) by ion exchange on the surface layer of the plate glass material. As a result, there is formed, on the surface layer of the plate glass material that has been subjected to the ion-exchange, a layer in which compressive stress has been generated, that is, the compressive stress layer 1a shown in FIG. 2. Along with the formation of the compressive stress layer 1a, there is formed, in a deep portion of the plate glass material, a layer in which tensile stress has been generated to keep balance of internal stress, that is, the tensile stress layer 1b. This means that, in the chemical strengthening step, the ion-exchange performed on the plate glass material transforms the surface layer of the plate glass material into the compressive stress layer 1a, and the deep portion other than the surface layer into the tensile stress layer 1b. The thickness d and compressive stress value F of the compressive stress layer 1a can be obtained by a known method such as wave-guide method or Babinet method. Herein, the description will be made on the assumption that the thickness d of the compressive stress layer 1a and the compressive stress value F are obtained by measurement using the wave-guide method.

(Decorating Layer Formation Step)

In a decorating layer formation step (S3), one or more decorating layers are formed on at least one surface of the plate glass material after the ion-exchange. The decorating layer may be, for example, a printed layer for decorating the cover glass 1, an antifouling layer for protecting the surface of the cover glass 1 from fouling, an antireflection layer for preventing light reflection from the surface of the cover glass 1, a conductive layer for ensuring electric conductivity for the surface of the cover glass 1, a transparent electrode layer of ITO (Indium Tin Oxide) or the like for a touch panel, and a protective layer for the transparent electrode layer. Such desired decorating layers may be formed by using a printing method, for example. The decorating layer(s) is/are formed on the surface of the plate glass material so as to conform the shape of each of small pieces cut from the plate glass material in the following shaping step.

The printed layer as one of the decorating layers will be described more specifically.

The printed layer is composed of a plurality of layers (multilayer structure) of coating materials. As a typical example where the printed layer is formed as a multilayer structure (where the first layer is negatively printed), the first layer is a layer in which an outer circumferential frame is printed. In the first layer, an equipment model name, a company name logo, various sensor holes, and the like are printed in void patterns.

The second layer is a layer in which the company name logo and the model name are printed in designated colors. The third layer is a lining layer for eliminating light-shieldability at the regions where the logo and the model name are printed and any pinholes in the frame printed region. The fourth layer is also a lining layer. The fifth layer is a transmittance adjusting filter ink layer to be printed on a region of a brightness sensor hole. The sixth layer is a alignment guideline layer for bonding the cover glass to a casing. Printing of these printed layers is carried out by setting the plate glass material to a printer with an end face thereof held by an alignment jig.

Next, among the decorating layers, the transparent electrode layer and the conductive layer will be described more specifically.

The transparent electrode layer is formed by forming a transparent conductive film such as an ITO film on the major surface of the plate glass material by using a sputtering method or the like, and then processing the transparent conductive film into a desired pattern shape by mean of a photolithography technique or a laser patterning technique using fundamental waves of a YAG (Yttrium Aluminum Garnet) laser or a CO₂ laser.

The conductive layer constitutes, for example, a signal wiring metal pattern (auxiliary conductor wires) made of Ag, Al, Mo or Cr, an alloy thereof, or a multilayer film thereof, lands to be connected to a flexible printed circuit board (FPC), and the like. The conductive layer is also used to electrically connect the transparent conductive layer to the outside of the cover glass (e.g. a position sensor circuit). The conductive layer may be formed, on the major surface of the plate glass material, by forming a metal film by depositing a film of a metallic conductive material by a sputtering method or the like, and processing the metal film into a desired pattern shape by a photolithography technique or the like.

By forming the transparent electrode layer and the conductive layer on the major surface of the plate glass material, it is possible to give a function as a touch panel to the small-sized glass substrate.

(Shaping Step)

In a shaping step (S4), the plate glass material which has been subjected to the chemical strengthening step (S2) and the decorating layer formation step (S3), is subjected to etching so that the plate glass material is cut to obtain a small-sized glass substrate. Specifically, a glass substrate that is subjected to contouring or outline processing and, if necessary, boring or the like by the etching is obtained. The decorating layer formed on the surface of the plate glass material is also cut together with the plate glass material by the etching. The glass substrate thus obtained constitutes the cover glass 1. Hereinafter, the shaping step (S4) for performing these processing steps will be described in more detail.

FIG. 4 is a flowchart showing summary of a procedure of the shaping step.

In the shaping step (S4), at least one surface of the plate glass material is coated with a resist film serving as an anti-etching film (S41). Subsequently, the resist film is exposed to light via a photomask having a pattern corresponding to a desired outline shape (S42). The exposed resist film is developed to form a resist pattern (S43), and then the resist pattern thus formed is post-baked (heat treated) (S44). Using this resist film having the resist pattern thus formed as a mask, the region to be etched of the plate glass material is etched (S45).

A resist material forming the resist film may be any material as long as it is resistant to an etchant used for etching the plate glass material. The plate glass material is etchable by wet etching with an aqueous solution containing hydrofluoric acid or by dry etching with fluorinated gas. Therefore, it is conceivable to use a resist material having excellent resistance to hydrofluoric acid, for example.

The resist film is formed to cover the entire of the decorating layer in order to protect the decorating layer from etching with the etchant. Further, the resist material is preferably a material that is not reactive with the decorating layer. Still further, an alkali-resisting material may be selected as the resist material according to properties of the decorating layer. For example, when the decorating layer is of an alkali-resisting material (a material difficult to dissolve in alkaline solution), a material soluble in alkaline solution may be selected as the resist material. By selecting the material in this manner, the resist film can be removed efficiently in the following peeling and cleaning step (S46).

The etchant used for etching the plate glass material may be a mixed acid of hydrofluoric acid and at least one of sulfuric acid, nitric acid, hydrochloric acid, and hydrofluosilicic acid. By shaping the plate glass material into a desired shape by etching, an end face of each small-sized glass substrate (etched end face) has an excellent surface condition that is free from microcracks which would be inevitably generated if the plate glass material is subjected to contouring by machining. Further, since the plate glass material is etched after the resist pattern is formed by photolithography, the glass substrate cut from the plate glass material also has an excellent dimensional accuracy. Therefore, even if a complicated outline shape is required for the cover glass 1, the cover glass 1 with an excellent dimensional accuracy can be obtained, and yet a high mechanical strength required for the cover glass 1 for portable equipment can be obtained. This contouring using photolithography and etching improves the productivity and reduces the processing cost. The etching is not limited to the wet etching as described above, but may be dry etching, for example, using fluorinated gas as an etchant.

The end face of each small-sized glass substrate is preferably a mirror surface in terms of mechanical strength and outer appearance quality. The term “mirror surface” means a surface finished like a mirror reflecting an object, in contrast to a satin-finished face having numerous fine irregularities.

The resist film may be formed by photolithography after applying a liquid or solid resist material. The resist film may be formed by patterning a resist material by screen printing and then thermally hardening the material. Further, the resist film may be formed by pasting a seal-type resist material that is obtained by preliminarily cutting or die-cutting the material with a laser or the like.

After the etching is performed, the small-sized glass substrate obtained by the etching is subjected to peeling of the resist film from the glass substrate and cleaning of the glass substrate (S46). A peeling solution for peeling the resist film from the glass base is preferably an alkaline solution of KOH, NaOH or the like. The resist material, the etchant, and the peeling solution may be selected as appropriate according to the composition of the plate glass material that is to be etched.

The method of forming the resist film is not limited to photolithography, but the resist film may be formed by using a known method such as printing, application of a liquid curable resin, or a seal. When the resist film is formed by pasting a sheet-type resist material that is preliminarily cut or die-cut with a laser or the like to the plate glass material, the resist film may be peeled by ultraviolet rays or thermally peeled.

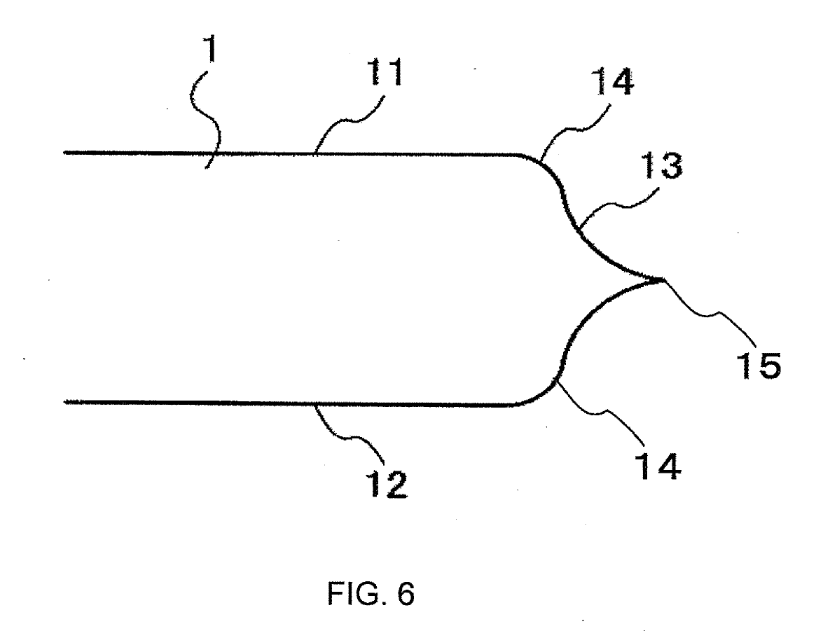

An end of the glass substrate obtained by the etching in this manner assumes a shape as shown in FIG. 6. Specifically, the end face of the glass substrate has a pair of curved faces 14 which are curved to project outward in a thickness direction in the major surfaces, and an apex 15 projecting from the curved faces 14 outward in a planar direction of the glass base. In the etching, the plate glass material is etched from both of a pair of major surfaces, whereby the end of the glass substrate can be shaped substantially symmetrically in the thickness direction, and hence the compressive stress to be described later can be made equal between the pair of major surfaces.

### <4. Characteristic Step in Method for Manufacturing Glass Substrate>

Next, the chemical strengthening step (S2) as the most characteristic step in the series of the above-mentioned steps of the method for manufacturing the cover glass 1 will be described in more detail.

As described above, the cover glass 1 is manufactured through a manufacturing process having a procedure in which the chemical strengthening step (S2) is performed on a plate glass material, the decorating layer formation step (S3) is further performed, and then the shaping step (S4) is performed by etching. Through the above-mentioned procedure, the plate glass material as a whole is hemically strengthened by the ion-exchange instead of the small-sized glass substrates being individually chemically strengthened by the ion-exchange. Therefore, the production efficiency can be improved in comparison with the conventional procedure in which chemical strengthening is performed after cutting into small pieces. Moreover, since the shaping step (S4) is performed by etching, it is possible to flexibly and easily cope with a complicated processing shape and to obtain an excellent dimensional accuracy and processed surface condition.

However, in the manufacturing process having the above-mentioned procedure, a plate glass material, which has been chemically strengthened by ion-exchange in the chemical strengthening step (S2), is cut by the etching. Therefore, the cover glass 1 is more apt to be damaged or broken during cutting, in comparison with the conventional procedure in which chemical strengthening is performed after a plate glass material is divided into small-sized pieces by contouring.

In order to avoid this, it is conceivable to set the thickness and the compressive stress value of the compressive stress layer 1a formed in the chemical strengthening step (S2) low enough so that no breakage occurs even by scribe cutting (see, for example, Patent Document 4). However, this measure is not necessarily effective enough to cope with improvement of strength and reduction of thickness of the cover glass 1.

This means that, in order to realize improvement of merchantability of the cover glass 1, it is desirable to form the compressive stress layer 1a strongly and thickly, whereas if it is strengthened too much, the shaping step (S4) after the chemical strengthening step may possibly become difficult.

In the above-mentioned respect, the present inventor conducted earnest studies. As a result, the inventor has obtained findings as described below. Herein, the particulars of the studies and the findings thus obtained will be described in detail.

(Relationship Between Compressive Stress and Processability of Strengthened Glass)

The inventor firstly studied a relationship between compressive stress and processability of a chemically strengthened plate glass material (chemically strengthened glass).

In these studies, the inventor focused attention to the compressive stress value of the chemically strengthened glass and thickness of the compressive stress layer as the values determining whether or not the processing of the chemically strengthened glass would be successful, and obtained an integrated value of the compressive stress applied to the entire of the chemically strengthened glass in a thickness direction thereof. The integrated value of the compressive stress can be obtained by integrating compressive stress values in the compressive stress layer 1a in a thickness direction of the chemically strengthened glass.

Specifically, citing the example of the chemically strengthened glass having the internal stress distribution shown in FIG. 2, the area of the region, shown in the figure, surrounded by a line segment σ indicating a distribution of the compressive stress, a line segment O indicating an equilibrium point of stress=0, and line segments S indicating the outer surfaces of the chemically strengthened glass was obtained approximately as the integrated value of the compressive stress. More specifically, as shown in the figure, a thickness of the compressive stress layer 1a is denoted by d [μm], and a maximum compressive stress value in the compressive stress layer 1a is denoted by F [MPa]. Then, an integrated value X of the compressive stress that is the value determining whether or not the glass processing is successful was obtained by using the equation (1) below.

X=F×d [MPa·μm] (1)

When the thickness of a layer in which tensile stress is generated (i.e. the tensile stress layer 1b) in the chemically strengthened glass is denoted by t₂ [μm], the thickness t₂ corresponds to a difference obtained by subtracting from the thickness t of the entire glass a product obtained by multiplying the thickness d of the compressive stress layer 1a by 2 (corresponding to the total thickness of the top and bottom surface layers), and hence the thickness t₂ can be represented by the equation (2) below.

t₂=t−2d [μm] (2)

An average tensile stress value Tₐᵥₑ [MPa] generated in the tensile stress layer 1b with a thickness t₂ is represented by the equation (3) below since the integrated value of the tensile stress is the same as the compressive stress integrated value X due to balance of force.

Tₐᵥₑ=X/t₂=(F×d)/(t−2d) [MPa] (3)

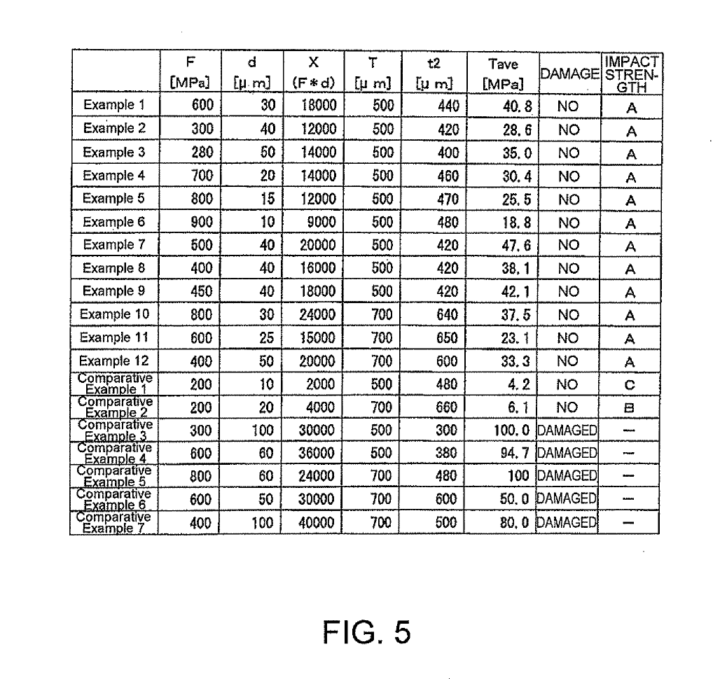

In these studies, the present inventor examined whether or not damages occurred when the cutting (contouring) by etching was performed and also examined strength properties of a small-sized piece cut by etching, for each of the chemically strengthened glasses of Example 1 to 12 and of Comparative Examples 1 to 7 shown in FIG. 5, each of which has the compressive stress layers 1a formed to have different maximum compressive stress values F [MPa] and different thicknesses d [μm]. The inventor further examined whether or not damages occurred when mechanical scribe cutting was performed. It should be noted that the chemically strengthened glasses of Examples 1 to 12 and Comparative Examples 1 to 7 include those with a thickness t of 500 μm (=0.5 mm) and those with a thickness t of 700 μm (=0.7 mm). Occurrence of damages mentioned herein principally means occurrence of microcracks. The glass material used in the examinations is an alumino-silicate glass containing, in percent by weight, 63.2% of SiO₂, 12.6% of Al₂O₃, 0.2% of Li₂O, 15.6% of Na₂O, 3.2% of K₂O, and 5.2% of MgO.

The aforementioned tests were conducted by the following method. Specifically, glass substrates shaped into a size of 50×100 mm were prepared, and each glass substrate was adhered and fixed to a metal frame such that the circumference of 3 mm wide of the glass was fringed with the frame. Double-sided adhesive tape was used to fix the glass to the metal frame. A steel ball weighing 100 g was dropped to the center of the glass fixed to the metal frame from the height of 50 cm and a damage rate of the glass was calculated. 30 glass substrates were prepared for each example and similar experiments were repeated. The glass substrates were evaluated for impact strength by classifying them into categories A to C according to the damage rate as follows:
A: The damage rate is 5% or less;
B: The damage rate is more than 5% and is 20%;
C: The damage rate is more than 20%.

FIG. 5 is an explanatory diagram showing specific examples of relationship of compressive stress with processability and impact strength of the chemically strengthened glass. The diagram shows a list of specific values of F, d, X, t, t₂ and Tₐᵥₑ, occurrence of damages during the cutting step by etching, and impact strength in association with one another, for each of the chemically strengthened glasses of Examples 1 to 12 and Comparative Examples 1 to 7. The compressive stress value of each chemically strengthened glass was measured by a wave-guide method using a glass surface stress meter “FSM-6000” made by Orihara Industrial Co. Ltd.

As seen from the result shown in the figure, in order to enable contouring by cutting the glass material by etching without causing damages to the small-sized glass substrates, it is desirable to set the average tensile stress value Tₐᵥₑ to less than 50 MPa regardless of the value of thickness t. This is based on the fact that the chemically strengthened glasses of Comparative Examples 3 to 7 were damaged by the etching.

Further, it can be seen from the result shown in the figure that it is desirable to set the average tensile stress value Tₐᵥₑ to 7 MPa or more in order to ensure impact strength for the small-sized glass substrates. This is based on the fact that the chemically strengthened glasses of Comparative Examples 1 and 2 exhibited poor impact strength (evaluated as B or lower).

Thus, from the above-mentioned studies, the present inventor has found that, when the average tensile stress value Tₐᵥₑ is set to less than 50 MP, glass substrates of various shapes can be produced by shaping using etching, even from a plate glass material that has been preliminarily chemically strengthened, without causing damages regardless of the value of thickness t of the plate glass material.

The average tensile stress value Tₐᵥₑ should be set to 50 MPa or less as described above and is preferably 45 MPa or less, and more preferably 40 MPa or less. Thus, it is possible to reliably prevent occurrence of damages when the strengthened glass is divided into small-pieces by etching.

On the other hand, if the average tensile stress value Tₐᵥₑ is too low, the impact strength will be reduced. Therefore, the value should be 7 MPa or more as described above. The average tensile stress value Tₐᵥₑ is preferably 10 MPa or more, more preferably 18 MPa or more, and still more preferably 20 MPa or more in order to reliably ensure the impact strength of the small-sized strengthened glass. It should be noted that, when mechanical scribe cutting was performed, microcracks (damages) were generated in all the chemically strengthened glasses of Examples 1 to 12 and Comparative Examples 1 to 7.

In order to improve the strength and scratch resistance of a glass substrate, it is generally conceivable to increase the thickness of a compressive stress layer to increase the compressive stress value. However, as the compressive stress value becomes greater, the internal tensile stress also becomes greater. When the average tensile stress value Tₐᵥₑ that is calculated based on an internal tensile stress becomes 50 MPa or more as described above, the risk will be increased that the glass substrate is damaged when it is subjected to shaping by etching. According to the invention, as long as the condition of the average tensile stress value Tₐᵥₑ of less than 50 MPa is satisfied, even if the compressive stress value is increased, or even if the glass material having a similar compressive stress but a small thickness is used, it is possible to process a strengthened glass material having an average tensile stress value Tₐᵥₑ of 7 MPa or more and having a high strength and scratch resistance without causing any damages.

(Processing Conditions in Chemical Strengthening Step)

Based on the findings as described above, the present inventor has come up with an idea of conducting the chemical strengthening step (S2) by performing ion-exchange while satisfying the conditions described below. The processing conditions for the chemical strengthening step (S2) established in this embodiment based on the foregoing findings are as follows.

In the chemical strengthening step (S2), when the thickness of a plate glass material to be processed is denoted by t [μm], the thickness of a compressive stress layer 1a to be formed is denoted by d [μm], the maximum compressive stress value in the compressive stress layer 1a is denoted by F (MPa), the compressive stress integrated value in the compressive stress layer 1a is denoted by X [MPa·μm], the thickness of a tensile stress layer 1b to be formed together with the compressive stress layer 1a is denoted by t₂ [μm], the average tensile stress value of the tensile stress layer is denoted by Tₐᵥₑ [MPa], and the relationships of X=F×d, t₂=t−2d and Tₐᵥₑ=X/t₂ are satisfied, ion-exchange is performed so as to satisfy the condition of the following expression (4).

7≦Tₐᵥₑ<50 [MPa] (4)

(Means for Satisfying Processing Conditions)

In order to satisfy the aforementioned processing conditions, the thickness d of a compressive stress layer 1a to be formed in the chemical strengthening step (S2) and the maximum compressive stress value F should be controlled so that they assume desired values.

The thickness d and the maximum compressive stress value F of the compressive stress layer 1a are affected by processing temperature and processing time in execution of the chemical strengthening step (S2), as well as by selection of a chemical strengthening process liquid and a concentration thereof. Further, those values also differ depending on composition of a glass material to be chemically strengthened and on the status of ion exchange in the glass. Therefore, when executing the chemical strengthening step (S2), these processing parameters such as processing temperature, processing time, selection of the process liquid, concentration of the process liquid, and selection of glass composition should be set as appropriate so that the thickness and the maximum compressive stress value F of the compressive stress layer 1a are controlled to the desired values.

Regarding the selection of glass composition, according to the invention, a glass material consisting of an alumino-silicate glass containing an alkali metal oxide is used. The alumino-silicate glass has better ion exchange properties in comparison with other glasses such as soda lime glass, alumino-borosilicate glass, borosilicate glass, and quartz glass. Therefore, the alumino-silicate glass is a glass material most suitable for performing the ion-exchange so as to satisfy the conditional expression (4).

In order to form a compressive stress layer 1a with a sufficient depth by preventing reduction of efficiency during ion exchange, it is conceivable to set the total content of Na₂O and Li₂O to 10 to 25% by weight, and to set the content of Li₂O to 0.1 to 7% by weight in order to form a deep compressive stress layer 1a in a short period of time. It is made possible, by setting these contents appropriately within allowable ranges, to control the thickness and the maximum compressive stress value of the compressive stress layer 1a to desired values. In addition to the alkali metal components such as Na₂O and Li₂O, it is also conceivable to introduce about 5 to 20% by weight of Al₂O₃ as a component to improve the ion exchange performance of the glass surface, and about 0.1 to 6% by weight of ZrO₂ as a component to improve the ion exchange rate and to improve the chemical durability and hardness of the glass. Further, the content of CaO is preferably limited to 0 to 8% by weight since it has an effect to reduce the exchange rate of alkali ions during ion exchange.

As a chemical strengthening process liquid, it is preferable to use a process liquid containing Na ions and/or K ions. Specifically, it is preferable to use a nitrate salt containing sodium nitrate (NaNO₃) and/or potassium nitrate (KNO₃) as a simple salt or a mixed salt. However, the process liquid is not limited to nitrate salt, but may be a sulfate salt, a bisulfate salt, a carbonate salt, a bicarbonate salt, or a halide. When the process liquid contains Na ions, the Na ions are exchanged with Li ions in the glass, while when the process liquid contains K ions, the K ions are exchanged with Li and Na ions in the glass. Further, when the process liquid contains Na and K ions, the Na and K ions are exchanged with Li and Na ions in the glass. Thus, the alkali metal ions in the glass surface layer are replaced with alkali metal ions having a greater ion radius by these ion exchange reactions, whereby the compressive stress layer 1a is formed in the glass surface layer and the glass is chemically strengthened.

When the glass composition, the temperature of the process liquid, and the processing time are fixed, the thickness d and the maximum compressive stress value F of the compressive stress layer 1a can be controlled by adjusting the mixing ratio of potassium nitrate and sodium nitrate in the process liquid. For example, when the Na ions in the glass are to be exchanged with the K ions in the process liquid, the maximum compressive stress value F can be decreased with the thickness d of the compressive stress layer 1a kept substantially constant by adding an appropriate amount (about 1 to 15% by mass) of molten salt of sodium nitrate to molten salt of potassium nitrate. When the Na ions in the process liquid are to be exchanged with Li ions in the glass containing a large amount (e.g. 3% by weight or more) of Li₂O as a glass component, the maximum compressive stress value F can be decreased by several to several tens percent by adding about 20 to 50% by mass of molten salt of sodium nitrate to molten salt of potassium nitrate.

When the glass composition is fixed and the composition of the chemical strengthening process liquid (molten salt) is the same, the thickness d and the maximum compressive stress value F of the compressive stress layer 1a and compressive stress integrated value X can be controlled by adjusting the processing temperature (the temperature of the process liquid in which the plate glass material is immersed) and the processing time (the time for which the plate glass material is immersed in the process liquid). Thus, as regards the thickness d of the compressive stress layer 1a, the thickness d becomes greater as the processing time becomes longer. As regards the compressive stress integrated value X, the compressive stress integrated value X becomes greater as the processing temperature becomes higher. It is important that the chemical strengthening step (S2) is performed at a temperature equal to or lower than the strain point of the glass material and at a temperature at which the molten salt will not be decomposed. Normally, the chemical strengthening step (S2) is performed at a temperature of 350 to 500° C., preferably 360 to 400° C., for about 1 to 12 hours, preferably for 2 to 8 hours.

When the processing temperature is set relatively low within the above-mentioned range and the processing time is set relatively long within the above-mentioned range, a compressive stress layer 1a having a thin thickness d and a large maximum compressive stress value F is formed.

As described above, by appropriately selecting a processing temperature, a processing time, a type of process liquid, and a glass composition of a plate glass material in execution of the chemical strengthening process (S2), it is made possible to control the thickness and the maximum compressive stress value F of the compressive stress layer 1a or the compressive stress integrated value X to desired values. As a result, a chemically strengthened glass satisfying the aforementioned processing conditions can be obtained.

### <5. Advantageous Effects of the Embodiment>

According to the method for manufacturing a cover glass 1 described in this embodiment, advantageous effects as described below can be obtained.

According to this embodiment, the cover glass 1 is obtained by chemically strengthening a plate glass material by ion-exchange and thereafter cutting the plate glass material by etching into small-sized pieces. Therefore, the plate glass material as a whole is chemically strengthened by ion-exchange instead of small-sized glass substrates being individually chemically strengthened by ion-exchange. Thus, it is possible to improve the production efficiency in comparison with the conventional procedure in which the chemical strengthening is performed after the material has been cut into small-sized pieces. As a result, the productivity in manufacturing the cover glass 1 can be improved.

Further, according to this embodiment, the plate glass material is cut into small-sized pieces by etching. Therefore, it is possible to cope with a complicated processing shape flexibly and easily, and to obtain an excellent dimensional accuracy and processed surface condition (for example, the surface roughness Ra of a cut surface is 10 nm or less).

Further, according to this embodiment, the ion-exchange is performed on a plate glass material before cutting by etching so as to satisfy the condition that the average tensile stress value Tₐᵥₑ in the glass is 7 MPa or more and less than 50 MPa. Therefore, even when a plate glass material which has been chemically strengthened is cut by etching, no damage such as microcracks will not be generated on the cut surfaces, and the cutting can be performed properly such that the impact strength requirement is satisfied. Since a compressive stress layer 1a can be formed as deeply and strongly as possible without causing difficulty in shaping due to excessive strengthening of the compressive stress layer 1a, the cover glass 1 manufactured according to the embodiment is sufficiently adaptable to demands for improved strength and reduced thickness. As a result, the merchantability as the cover glass 1 can be enhanced sufficiently.

Based on the foregoing, it can be said that when a cover glass 1 is manufactured by using the method according to the embodiment, it is made possible to realize improvement of both productivity and merchantability of the cover glass 1.

Further, according to the embodiment, one or more decorating layers are formed on at least one surface of a plate glass material which has been chemically strengthened by ion-exchange, and then the plate glass material having the decorating layer(s) formed thereon is cut by etching. Thus, the decorating layer(s) formed on the surface of the plate glass material is/are cut together with the plate glass material by the etching. Accordingly, instead of forming a decorating layer on each of small-sized glass substrate, the decorating layer is formed on the plate glass material as a whole, which improves the production efficiency in manufacture of the cover glass 1. When the decorating layer is formed on the plate glass material by a printing method, in particular, the processing time and the processing manhour are the same as when a decorating layer is formed individually on a small-sized glass substrate by a printing method. This makes it possible to remarkably shorten the processing time required for each of the small-sized glass substrates.

In a conventional method for manufacturing a glass substrate, when a plate glass material is to be cut into small-sized pieces by etching before it is chemically strengthened, a plurality of glass substrates must be transferred from one of a holder and a transport member to the other between the steps after the etching. This transfer work is performed a plurality of number of times through all the steps, and this transfer work may possibly cause cracks or damages to be generated on the end face of the glass substrate. In contrast, according to this embodiment, a plate glass material is chemically strengthened and thereafter the plate glass material is cut into small-sized substrates by etching, whereby the number of steps can be reduced and the number of times of transfer work also can be reduced. As a result, it is possible to suppress occurrence of cracks or damages on the end face of the glass substrate, and to improve the strength quality of the cover glass 1.

Moreover, since the cutting is done by etching instead of scribe cutting, it is possible to cope with a complicated processing shape flexibly and easily, and also to obtain an excellent dimensional accuracy and processed surface condition. Thus, even when a decorating layer is formed, it is made possible to realize improvement of both productivity and merchantability of the cover glass 1.

### <6. Others>

In the embodiment, a method for manufacturing a cover glass 1 for portable equipment has been described as a suitable example to embody the invention. However, this invention is not limited thereto.

For example, the glass substrate to be manufactured in the invention may be a glass substrate other than the cover glass 1 for portable equipment, as long as it is obtained by subjecting a plate glass material which has been chemically strengthened by ion-exchange to shaping by etching. In this case as well, it is made possible by applying the invention to realize improvement of both productivity and merchantability of the glass substrate.

As described above, the invention is not limited to the content of the embodiment described above, but may appropriately be modified without departing from the scope of the invention.

What is claimed is:

1. A method for manufacturing a strengthened glass substrate comprising:
a chemical strengthening step of performing ion-exchange on a plate glass material to form a compressive stress layer in a surface layer of the plate glass material while forming a tensile stress layer in a deep portion other than the surface layer; and
a shaping step of performing etching on the plate glass material which has been subjected to the chemical strengthening step to cut the plate glass material into small-sized glass substrates, wherein:
the plate glass material is prepared, consisting of alumino-silicate glass containing an alkali metal oxide; and
in the chemical strengthening step, the ion-exchange is performed to generate such a tensile stress that the plate glass material is not damaged by the etching.

2. The method for manufacturing a strengthened glass substrate according to claim 1, wherein in the chemical strengthening step, the ion-exchange is performed to satisfy the condition of
7≦Tₐᵥₑ<50 [MPa]
when the thickness of the plate glass material is denoted by t [μm], the thickness of the compressive stress layer is denoted by d [μm], the maximum compressive stress value of the compressive stress layer is denoted by F [MPa], the compressive stress integrated value of the compressive stress layer is denoted by X [MPa·μm], the thickness of the tensile stress layer is denoted by t₂ [μm], the average tensile stress value of the tensile stress layer is denoted by Tₐᵥₑ [MPa], and the relationships represented by the equations X=F×d, t₂=t−2d and Tₐᵥₑ X/t₂ are satisfied.

3. The method for manufacturing a strengthened glass substrate according to claim 1, further comprising, after the chemical strengthening step and before the shaping step, a decorating layer formation step of forming one or more decorating layers on at least one of the surfaces of the plate glass material which has been subjected to the ion-exchange,
wherein in the shaping step performed after the decorating layer formation step, the plate glass material having the decorating layer formed thereon is cut by the etching.

4. The method for manufacturing a strengthened glass substrate according to claim 3, wherein the decorating layer formation step comprises a printing operation of performing printing on the major surface of the plate glass material with its end face being held.

5. The method for manufacturing a strengthened glass substrate according to claim 3, wherein the decorating layer formation step comprises an operation of forming a conductive layer and a transparent conductive layer on the major surface of the plate glass material.

6. The method for manufacturing a strengthened glass substrate according to claim 1, wherein as the plate glass material, used is a glass containing 50 to 75% by weight of SiO₂, 5 to 20% by weight of Al₂O₃, and at least one alkali metal oxide selected from Li₂O, Na₂O and K₂O.

7. The method for manufacturing a strengthened glass substrate according to claim 6, wherein as the plate glass material, used is a glass containing 8% by weight or more of Na₂O and 8% by weight or less (including 0) of CaO.

8. The method for manufacturing a strengthened glass substrate according to claim 1, wherein the strengthened glass substrate is a glass substrate for use as a cover glass for electronic equipment.

9. A strengthened glass substrate consisting of an alumino-silicate glass containing an alkali metal oxide, having a compressive stress layer in a surface layer and a tensile stress layer in a deep portion, wherein:
the strengthened glass substrate is subjected to ion-exchange satisfying the condition of
7≦Tₐᵥₑ<50 [MPa]
when the thickness of the alumino-silicate glass is denoted by t [μm], the thickness of the compressive stress layer is denoted by d [μm], the maximum compressive stress value of the compressive stress layer is denoted by F [MPa], the compressive stress integrated value of the compressive stress layer is denoted by X [MPa·μm], the thickness of the tensile stress layer is denoted by t₂ [μm], the average tensile stress value of the tensile stress layer is denoted by Tₐᵥₑ [MPa], and the relationships represented by the equations X=F×d, t₂=t−2d and Tₐᵥₑ=X/t₂ are satisfied; and
the strengthened glass substrate has an end face which has been subjected to etching.

10. The strengthened glass substrate according to claim 9, wherein the end face of the strengthened glass substrate has a pair of curved faces projecting outward in a thickness direction of the major surface and an apex projecting from the curved faces outward in a planar direction of the glass base.

11. The strengthened glass substrate according to claim 9, wherein no compressive stress layer is formed at least in a partial region of the end face of the strengthened glass substrate.

12. The strengthened glass substrate according to claim 9, wherein the alumino-silicate glass is a glass containing, as glass components, 50 to 75% by weight of SiO₂, 5 to 20% by weight of Al₂O₃, and at least one alkali metal oxide selected from Li₂O, Na₂O and K₂O.

13. The strengthened glass substrate according to claim 12, wherein the alumino-silicate glass is a glass containing 8% by weight or more of Na₂O and 8% by weight or less (including 0) of CaO.

14. The strengthened glass substrate according to claim 9, wherein the strengthened glass substrate is a glass substrate for use as a cover glass for electronic equipment.
